(19) United States
(12) Patent Application Publication
(10) Pub. No.: US 2019/0026841 A1
(43) Pub. Date: Jan. 24, 2019

(54) DISTRIBUTION AND ACCESS MANAGEMENT OF INDIVIDUAL MEDIA CONTENT USING CODE EMBEDDED WITHIN MEDIA CONTENT

(71) Applicant: SONY CORPORATION, Tokyo (JP)

(72) Inventor: JENKE WU KUO, San Diego, CA (US)

(21) Appl. No.: 15/653,693

(22) Filed: Jul. 19, 2017

(51) Int. Cl. G06Q 50/00; G06F 17/30; H04L 29/08

(52) U.S. Cl. CPC G06Q 50/01; H04N 21/266; H04L 67/1097; G06F 17/30035

(57) ABSTRACT

Various aspects of an electronic device and method for distribution and access management of individual media content are disclosed herein. The electronic device includes a memory configured to store a first media content and a plurality of eraser codes. The electronic device further includes a central processing unit (CPU) configured to detect a content-type of the first media content. The CPU selects a first eraser code from the plurality of eraser codes based on the detected content-type. The selected first eraser code is embedded within the first media content based on the detected content-type. The first media content with the embedded first eraser code is then communicated to a second electronic device. The first electronic device controls deletion of at least a portion of the first media content at the second electronic device based on a communicated control instruction and the embedded first eraser code.

### CROSS-REFERENCE TO RELATED APPLICATIONS/INCORPORATION BY REFERENCE

None.

### FIELD

Various embodiments of the disclosure relate to information security, file distribution control, and data access management technologies. More specifically, various embodiments of the disclosure relate to an electronic device and a method for distribution and access management of individual media content using code embedded within media content.

### BACKGROUND

Recent years have witnessed a growth spurt in the number of file distribution systems, social media applications, and platforms available in the market. The social media applications may enable users to share media content, such as video files, audio files, image files, video streams, audio streams, podcasts, and other documents to recipient devices/users. In certain scenarios, a user of a sender device may inadvertently communicate private media content to an undesired recipient device. In such a case, the user may be unable to track or handle the communicated private media content at the recipient device. Moreover, after reception of the private media content, a recipient may forward the private media content to undesired or unauthorized viewers. It may be difficult for the user to prevent further distribution and access of the communicated media content once is has been inadvertently communicated to an undesired recipient device. The aforementioned deficiencies of conventional file distribution systems and social media platforms may pose a serious threat to the privacy of the user.

In the conventional systems, a common approach to provide a secure access is usually limited for certain formats of document, such as a word processor files or portable document formats. Such a document may be locked with a password before the document is communicated to the recipient device. A client application may be installed in the recipient device. If the entered user password by the recipient does not match with the password stored with the document or a server, then the client application may erase the media content instantly. However, password-based protection is vulnerable for various reasons. For example, the recipient may share the password with other users, and thereby increase the difficulty to handle further sharing of the communicated document(s). Further, an unauthorized viewer may obtain the password via unauthorized means, and thereby gain access to the media content. If an authorized user enters an incorrect password, then the client application may render the media content to be inaccessible to the authorized user. Consequently, a sender of the document has to take extensive steps to protect the password from the unauthorized viewers, while making the password readily available to the authorized user. Therefore, the aforementioned approach may be deemed to be cumbersome. Currently, another approach to provide a secure access for media content is via application of encryption techniques or centralized subscription-based access control systems. However, it may be difficult to track or protect further distribution of individual media content, such as a particular video or image, once the media content is downloaded at the recipient device. As a result of the proliferation of social media applications and platforms, multiple copies of a media content may be made and stored in a plethora of network servers. In such cases, it may be a challenging task to track or delete copies of the media content stored in the network servers.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for distribution and access management of individual media content is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for distribution and access management of individual media content, in accordance with an embodiment of the disclosure.

FIG. 2 is a block diagram that illustrates an exemplary electronic device for distribution and access management of individual media content, in accordance with an embodiment of the disclosure.

FIG. 3 is a block diagram that illustrates another exemplary electronic device for distribution and access management of individual media content, in accordance with an embodiment of the disclosure.

FIG. 4 illustrates an exemplary scenario for implementation of the disclosed electronic device and method for distribution and access management of individual media content, in accordance with an embodiment of the disclosure.

FIG. 5 is a flowchart that illustrates an exemplary method for distribution and access management of individual media content, in accordance with an embodiment of the disclosure.

FIG. 6 is a flowchart that illustrates another exemplary method for distribution and access management of individual media content, in accordance with an embodiment of the disclosure.

### DETAILED DESCRIPTION

The following described implementations may be found in the disclosed electronic device and method for distribution and access management of individual media content. Various embodiments of the disclosed electronic device and method enables a sender to handle communicated media content at a recipient device and control further distribution of the communicated media content from the recipient device to any undesired or unauthorized device/user.

Exemplary aspects of the disclosure may include a first electronic device for distribution and access management of individual media content. The first electronic device may be a sender device and a second electronic device may be a recipient device. The first electronic device may include a memory and a central processing unit (CPU). The memory may be configured to store a first media content and a plurality of eraser codes. The CPU may be configured to detect a content-type of the first media content. The CPU may be further configured to select a first eraser code from the plurality of eraser codes based on the detected content-type of the first media content. The CPU may be further configured to embed the selected first eraser code within the first media content based on the detected content-type. The CPU may be further configured to communicate the first media content comprising the embedded first eraser code to a selected second electronic device. The CPU may be configured to communicate a control instruction to the selected second electronic device. The CPU may be configured to control deletion of at least a portion of the first media content at the second electronic device based on the communicated control instruction and the embedded first eraser code. The first media content may be one of a video file, an audio file, an image file, or a media content stream.

In accordance with an embodiment, the CPU may be further configured to control the deletion of at least the portion of the first media content at the second electronic device using the embedded first eraser code which may be invoked to delete the portion of the first media content after elapse of a defined time period based on the communicated control instruction. In accordance with an embodiment, the CPU may be further configured to change a first timestamp in the embedded first eraser code to a second timestamp to control the deletion of the portion of the first media content at the second timestamp, based on the communicated control instruction. The CPU may be configured to detect a change in an access rights setting in a memory space of the second electronic device in which the first media content may be stored based on a message received from the second electronic device. The first media content may be automatically deleted by the embedded first eraser code from the memory space, based on a change in the access rights setting to a read-only access right assigned to the memory space.

In accordance with an embodiment, the CPU may be further configured to embed the selected first eraser code in the first media content as self-executable metadata. The CPU may be configured to control deletion of the first media content in entirety at the second electronic device based on the communicated control instruction. In accordance with an exemplary aspect of the disclosure, the first electronic device may be a recipient device and the second electronic device may be the sender device. In such a case, the CPU may be configured to receive a first media content comprising an embedded first eraser code from the second electronic device. The CPU may be configured to receive a control instruction from the second electronic device. The CPU may be further configured to update a change in one or more view parameters of the first media content in the embedded first eraser code of the first media content. Moreover, the CPU may be configured to compare the update in the one or more view parameters with one or more access control parameters provided in the embedded first eraser code of the first media content. The CPU may be configured to control deletion of at least a portion of the first media content stored in a memory space in the first electronic device based on the received control instruction and the comparison.

The one or more access control parameters may comprise at least one of a view count limit, a user-defined expiration time for the first media content, a recipient identifier (ID) associated with the first media content. Further, the one or more view parameters may comprise at least one of a current view count associated with the first media content, a user identifier (ID) associated with a user of the first electronic device. The CPU may be further configured to determine the one or more view parameters of the first media content each time the first media content is accessed.

In accordance with yet another embodiment, the CPU may be further configured to modify a first timestamp in the embedded first eraser code to a second timestamp to control the deletion of the portion of the first media content at the second timestamp, based on the received control instruction. The CPU may be further configured to execute the embedded first eraser code to delete the first media content in its entirety based on a change in an access rights setting to a read-only access right. The access rights setting of read-only access right may be assigned to a memory space in the first electronic device in which the first media content may be stored.

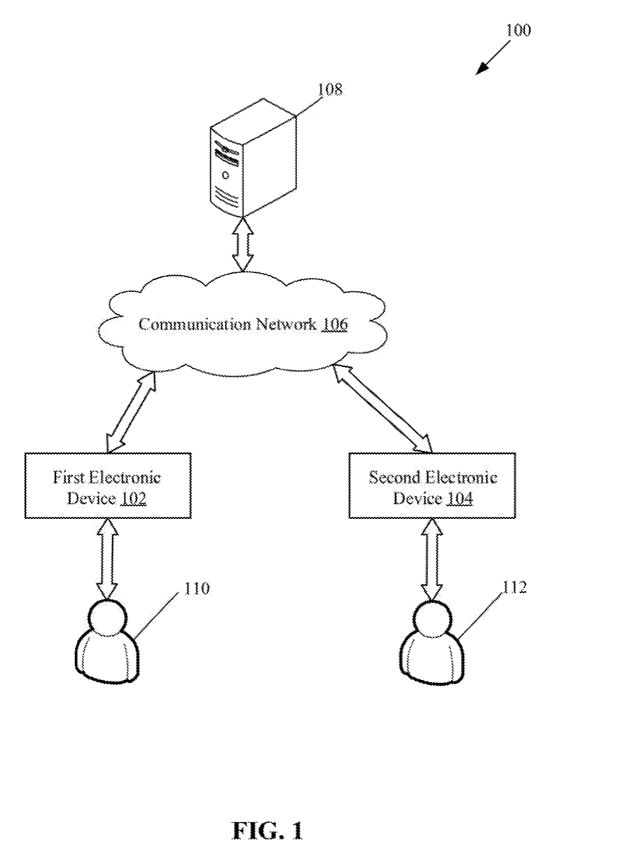

FIG. 1 is a block diagram that illustrates an exemplary network environment 100 for distribution and access management of individual media content, in accordance with an embodiment of the disclosure. With reference to FIG. 1, there is shown a network environment 100. The network environment 100 may include one or more electronic devices, such as a first electronic device 102 and a second electronic device 104, a communication network 106, one or more database servers, such as a server 108, and one or more users, such as a first user 110 and a second user 112. The first electronic device 102 may be associated with the first user 110. The second electronic device 104 may be associated with the second user 112. The first electronic device 102, the second electronic device 104, and the server 108 may be communicatively coupled to each other, via the communication network 106.

The first electronic device 102 and the second electronic device 104 may comprise suitable circuitry, interfaces, and/or code that may be configured to process and communicate various media content, such as video files, audio files, image files, audio streams, podcasts, or documents, to each other via the communication network 106. The first electronic device 102 may be configured to communicate the media content, to the second electronic device 104 and remotely control deletion of the media content at the second electronic device 104. Examples of the first electronic device 102 and the second electronic device 104 may include, but are not limited to, a smartphone, a tablet, a digital camera, a camcorder, a head-mounted device (HMD), a smart-glass, a laptop, a computer workstation, an augmented reality based device, a computing device, a server, and/or other consumer electronic (CE) devices.

The server 108 may comprise suitable circuitry, interfaces, and/or code that may be configured to store media content. Examples of the server 108 may include, but are not limited to, a database server, a file server, an application server, a cloud server, a web server, or a combination thereof.

The communication network 106 may include a communication medium through which the first electronic device 102 and the second electronic device 104 may communicate with each other or with the server 108. Examples of the communication network 106 may include, but are not limited to, the Internet, a cloud network, a Wireless Fidelity (Wi-Fi) network, a Local Area Network (LAN), and/or a Metropolitan Area Network (MAN). Various devices in the network environment 100 may be configured to connect to the communication network 106, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, IEEE 802.11b, IEEE 802.11g, IEEE 802.11n, and/or any other IEEE 802.11 protocol, multi-hop communication, wireless access point (AP), device to device communication, cellular communication protocols, Light-fidelity (Li-Fi), Internet-of-Things (IoT) network, or Bluetooth (BT) communication protocols, or a combination or variants thereof.

In operation, the first electronic device 102 may be configured to store a first media content and a plurality of eraser codes. In one example, the first electronic device 102 may be configured to store a plurality of media content. The first electronic device 102 may be configured to retrieve the first media content from a memory of the first electronic device 102 or the server 108. Examples of the first media content or the plurality of media content may include, but are not limited to a video, an audio, or an image file, or a document, such as a word processor file or a portable document format (PDF). In some embodiments, first media content may also refer to streaming content, for example, an audio stream, a video stream, a podcast, and the like. The plurality of eraser codes may refer to a set of instructions, logic, or code, which may be self-executable, and on execution may perform defined operations. Each of the plurality of eraser codes may include one or more access control parameters, for example, a view count limit, a user-defined expiration time for a media content, a placeholder for one or more recipient identifiers (IDs) of one or more recipients to whom a media content may be communicated. The view count limit may refer to a user-specified numeric value or a digital counter that indicates a maximum number of times, a media content may be consumed (i.e. viewed, heard, or played) by a designated recipient. The user-defined expiration time may refer to a maximum duration of time (i.e. a specified time limit) a media content may be stored. The one or more recipient IDs may refer to users IDs or device IDs authorized or selected by the first user 110 at the time of communication of a media content, such as the first media content.

Each of the plurality of eraser codes may further include one or more view parameters, for example, a current view count, a placeholder for one or more user identifiers (IDs) of one or more users who may access the media content. The current view count may refer to a numeric value or a digital counter that indicates a number of times that a media content has been consumed (i.e. viewed, heard, or played) by one or more users. The one or more user IDs may refer to users IDs or device IDs of the one or more users.

The first electronic device 102 may be configured to select a media content, such as the first media content, to be communicated to a recipient device, such as the second electronic device 104. The first electronic device 102 may be configured to determine a content-type of the selected first media content. For example, the first electronic device 102 may be configured to detect the content-type of the selected first media content as a video file in a Moving Pictures Expert Group 2 (MPEG2) container format. The MPEG2 container format is a file format to store compressed video files and audio files. The first electronic device 102 may be configured to select a first eraser code from the plurality of eraser codes based on the detected content-type of the first media content. For example, an eraser code suited for the video file may be selected when the detected content-type corresponds to a video file. Similarly, another eraser code suited for an image file may be selected when the detected content-type corresponds to an image file.

In accordance with an embodiment, the first electronic device 102 may be configured to embed the selected first eraser code within the first media content. The first electronic device 102 embeds the selected eraser code based on the detected content-type. In some embodiments, the first electronic device 102 may be configured to embed the selected eraser code as a self-executable metadata or logic in the first media content.

The first electronic device 102 may be configured to communicate the first media content comprising the first eraser code embedded in the first media content, to a selected second electronic device 104. The first media content may be communicated to the second electronic device 104, via the communication network 106. In certain scenarios, one or more social media applications may be installed in the first electronic device 102. The first electronic device 102 may communicate the first media content to the second electronic device 104 via a social media application or platform. The social media platform may store the first media content in a social media server, such as the server 108, prior to the communication of the first media content to the second electronic device 104.

The second electronic device 104 may be configured to receive the first media content comprising the first eraser code embedded, from the first electronic device 102. In some embodiments, the second electronic device 104 may be configured to download the first media content from the server 108, in cases where the server 108 facilitates the communication or in a peer-to-peer communication. An example may be the social media application or platform, in which a server, such the server 108, may facilitate sharing of media content among users. Each time the second user 112 consumes the first media content (for example, views the video file), the one or more view parameters associated with the first media content may be determined and then updated in the first eraser code embedded in the first media content. For example, if a parameter, such as the current view count, of the one or more view parameters associated with the first media content, may be 4, and if a user further views the first media content, then the current view count may be updated to 5. The second electronic device 104 may be configured to update a change in the one or more view parameters of the first media content in the first eraser code embedded in the first media content.

In accordance with an embodiment, the second electronic device 104 may be configured to compare the update in the one or more view parameters with one or more access control parameters provided in the first eraser code embedded in the first media content. Thereafter, the second electronic device 104 may be configured to communicate a notification message to the first electronic device 102. For example, the view count limit set in the one or more access control parameters for the first media content is “5.” The current view count updated in the one or more view parameters is also “5”. Based on the comparison of the view count limit with the current view count in the first eraser code embedded in the first media content, the second electronic device 104 may ascertain that the current view count has reached the view count limit or threshold. The second electronic device 104 may be configured to communicate a notification message using the first eraser code embedded in the first media content, to the first electronic device 102. The notification message may indicate that the view count limit or threshold has been reached. The notification may include audio based, a text based, an image based, and a video based notification message.

In some embodiments, the notification message may comprise information pertaining to a change in an access right setting of a memory space in the second electronic device 104. For example, after downloading of the first media content in a memory space of the second electronic device 104, if the access right setting of the memory space has been changed to read only, the notification message may indicate that the access right setting has been changed to read only. In such a case, the first media content may be automatically deleted from the memory space, by the first eraser code embedded in the first media content. In other words, the first eraser code embedded in the first media content, may be auto-executed by the second electronic device 104 for the deletion of the first media content.

In accordance with an embodiment, the first electronic device 102 may be configured to receive the notification message from the second electronic device 104. The first electronic device 102 may be configured to present the notification message to the first user 110. The notification message may be output as an audio, an image, a video, a text, or combination thereof.

The first electronic device 102 may receive an input that corresponds to one or more user-preferences provided by the first user 110. The one or more user preferences may include a first preference to erase the first media content immediately, a second preference to erase the first media content partially, a third preference to prevent the second electronic device 104 from erasing the first media content, and a fourth preference to modify one or more access control parameters of the first eraser code embedded within the first media content.

In accordance with an embodiment, the first electronic device 102 may be configured to generate a control instruction based on the one or more user preferences. In some embodiments, the control instruction may be generated independent of the user-preferences. Alternatively stated, the control instructed may be generated automatically based on the received notification without requiring any user input or the one or more user-preferences. The control instruction may include an instruction to delete the first media content in entirety or delete certain portion of the first media content (for example, certain frames in the video file). In some embodiments, the control instruction may include an instruction to modify the one or more access control parameters in the first eraser code at the remote device, such as the second electronic device 104.

The first electronic device 102 may be configured to communicate the control instruction to the selected second electronic device 104. The first electronic device 102 may be configured to control deletion of the first media content in its entirety at the second electronic device 104. The deletion of the first media content at the second electronic device 104 is controlled based on the communicated control instruction and the first eraser code embedded within the first media content at the second electronic device 104. In some embodiments, the first electronic device 102 may be configured to control deletion of at least a portion of the first media content. For example, in certain scenarios, the control instruction may instruct the second electronic device 104 to selectively delete user specified portions of the first media content. In case the first media content is a video, certain frames (copyrighted or confidential material) may be deleted from the video by the first eraser code, instead of the entire video.

In accordance with an embodiment, the second electronic device 104 may be configured to delete the portion of the first media content based on the received control instruction and the first eraser code embedded in the first media content. The deletion of the portion of the first media content at the second electronic device 104 may be controlled by use of the first eraser code embedded in the first media content, which is invoked to delete the portion of the first media content based on the received control instruction.

In some embodiments, after elapse of a defined or particular time period, the first eraser code embedded in the first media content may be invoked by the communicated control instruction to delete the portion of the first media content. In one example, the defined time period may correspond to the user defined expiration time comprised in the one or more access control parameters. In another example, the defined time period may be set in the one or more user preferences. In one example, the first electronic device 102 may be configured to change the first timestamp in the first eraser code embedded in the first media content, to a second timestamp. The first electronic device 102 may be configured to control the deletion of the portion of the first media content at the second timestamp, based on the communicated control instruction. In another example, the first electronic device 102 may be configured to deny access of the second user 112 to the first media content based on the communicated control instruction.

In accordance with an exemplary aspect of the disclosure, the first electronic device 102 may be a recipient device and the second electronic device 104 may be the sender or initiator device. In such a case, the first electronic device 102 may be configured to receive the first media content comprising the embedded first eraser code from the second electronic device 104. The first electronic device 102 may be further configured to receive the control instruction from the second electronic device 104, via the communication network 106.

The first electronic device 102 may determine the one or more view parameters associated with the first media content. The first electronic device 102 determines the one or more view parameters by invoking the first eraser code embedded in the first media content. In one example, the first electronic device 102 may be configured to increment the current view count of the one or more view parameters each time a viewer accesses the first media content on the first electronic device 102. The first electronic device 102 may update a change in the one or more view parameters in the first eraser code embedded within the first media content.

The first electronic device 102 may be further configured to compare the update in the one or more view parameters with the one or more access control parameters provided in the first eraser code embedded in the first media content. For example, the first electronic device 102 may be configured to compare the current view count with the view count limit of the one or more access control parameters of the first eraser code embedded in the first media content. The first electronic device 102 may compare the update in the one or more view parameters with the one or more access control parameters by invoking the first eraser code embedded in the first media content. The first electronic device 102 may generate the notification message based on the comparison. In an exemplary illustration, if the recipient ID of the first electronic device 102 does not match with the recipient ID specified in the first eraser code embedded in the first media content, then the first electronic device 102 may communicate the notification message that comprises the recipient ID of the first electronic device 102 to the second electronic device 104. The first electronic device 102 may be further configured to erase the first media content stored in a memory space in the first electronic device 102, by invoking the first eraser code embedded in the first media content. Alternatively stated, the first eraser code embedded in the first media content, may be triggered to destroy itself and the first media content.

In contrast to the conventional and common approach of erasing a communicated media content from the recipient device by using a client application, the first electronic device 102 uses the first eraser code. The first electronic device 102 embeds the first eraser code in the first media content before communicating the first media content to the second electronic device 104. The first electronic device may further receive the one or more user preferences and generates the control instruction based on the one or more user preferences. The first electronic device 102 communicates the control instruction to the second electronic device 104. The first user 110 may inadvertently send classified or private media content to unauthorized viewers. The first electronic device 102 provides an ability to the first user 110 to control deletion of the first media content at the second electronic device 104 via the communicated control instruction and the first eraser code embedded in the first media content. The first electronic device 102 also provide a capability to control further undesired distribution of the first media content by the second electronic device 104. For example, the second user 112 of the second electronic device 104 may attempt to further communicate the first media content that includes the first eraser code, to any other device/users not specified in the recipient ID in the access control parameters of the first eraser code embedded in the first media content. Thus, a notification of such attempt by the second electronic device 104 may be sent to the first electronic device 102 by use of the first eraser code. The first eraser code embedded in the first media content may be further auto-executed at the second electronic device 104 to delete the first media content at the second electronic device 104 or prohibit the second electronic device 104 for further distribution of the first media content.

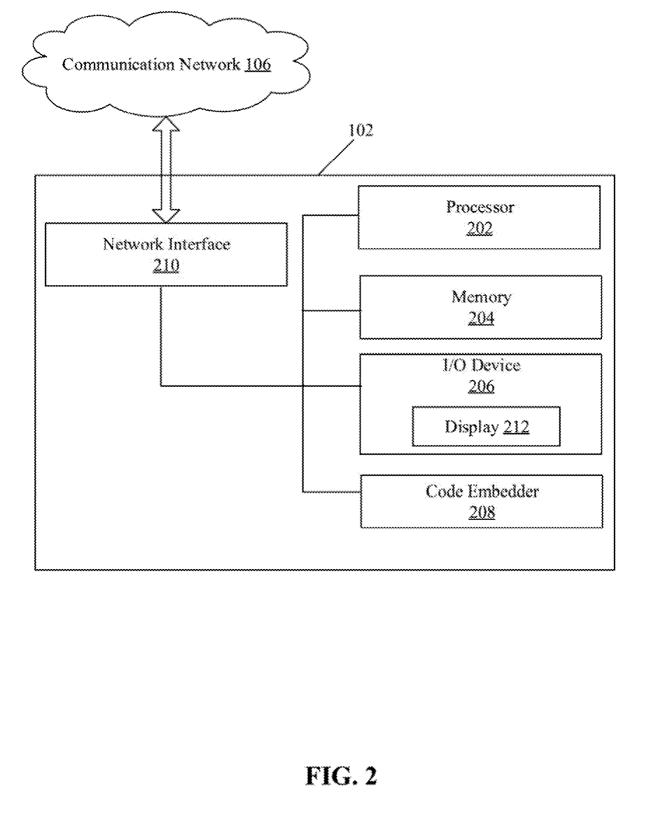

FIG. 2 is a block diagram that illustrates an exemplary electronic device for distribution and access management of individual media content, in accordance with an embodiment of the disclosure. FIG. 2 is explained in conjunction with elements from FIG. 1. With reference to FIG. 2, there is shown an exemplary electronic device, such as the first electronic device 102. The first electronic device 102 may include one or more processors, such as a processor 202, a memory 204, an I/O device 206, a code embedder 208, and a network interface 210. The I/O device 206 may include a display 212. The processor 202 may be communicatively coupled with the memory 204, the I/O device 206, the code embedder 208, and the network interface 210. The network interface 210 may be configured to communicate with the server 108, via the communication network 106.

The processor 202 may comprise suitable logic, circuitry, interfaces, and/or code that may be configured to execute a set of instructions stored in the memory 204. The processor 202 may be implemented based on a number of processor 202 technologies known in the art. In one example, the processor 202 may be a central processing unit (CPU). Other examples of the processor 202 may be an X86-based processor 202, a Reduced Instruction Set Computing (RISC) processor 202, an Application-Specific Integrated Circuit (ASIC) processor 202, a Complex Instruction Set Computing (CISC) processor 202, and/or other processors.

The memory 204 may comprise suitable logic, circuitry, and/or interfaces that may be configured to store a set of instructions executable by the processor 202. The memory 204 may be configured to store the plurality of media content and the plurality of eraser codes. The memory 204 may be configured to store operating systems and associated applications. The memory 204 may be further configured to store various algorithms to detect face, gesture, shape, and/or edge. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may comprise suitable logic, circuitry, interfaces, and/or code that may be configured to receive an input from a user, such as the first user 110. The I/O device 206 may be further configured to provide an output to the first user 110. The I/O device 206 may comprise various input and output devices that may be configured to communicate with the processor 202. Examples of the input devices may include, but are not limited to, a touch screen, a keyboard, a mouse, a joystick, a microphone, and/or the image-capture unit. Examples of the output devices may include, but are not limited to, the display 212 and/or a speaker.

The code embedder 208 may comprise suitable logic, circuitry, interfaces, and/or code that may be configured to perform one or more operations, such embedding of a first eraser code into a first media content. In one example, the code embedder 208 may be configured to embed the selected eraser code as a self-executable metadata in the first media content.

The network interface 210 may comprise suitable logic, circuitry, interfaces, and/or code that may be configured to establish communication between the first electronic device 102, the second electronic device 104, and the server 108, via the communication network 106. The network interface 210 may be implemented by use of various known technologies to support wired or wireless communication of the first electronic device 102 with the communication network 106. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), light fidelity (Li-Fi), Wi-MAX, a protocol for email, instant messaging, and/or Short Message Service (SMS).

The display 212 may comprise suitable logic, circuitry, interfaces, and/or code that may be configured to generate and render a user interface to receive input to set the one or more access control parameters, one or more user-preferences, and media content. In accordance with an embodiment, the display 212 may be able to receive input from the first user 110. In such a scenario, the display 212 may be a touch screen that enables the first user 110 to provide input. The touch screen may correspond to at least one of a resistive touch screen, a capacitive touch screen, or a thermal touch screen. In accordance with an embodiment, the display 212 may receive the input through a virtual keypad, a stylus, a gesture-based input, and/or a touch-based input. The display 212 may be realized through several known technologies such as, but are not limited to, at least one of a Liquid Crystal Display (LCD) display, a Light Emitting Diode (LED) display, a plasma display, and/or an Organic LED (OLED) display technology, and/or other display. In accordance with an embodiment, the display 212 may refer to a display screen of smart-glass device, a see-through display, a projection-based display, an electro-chromic display, and/or a transparent display.

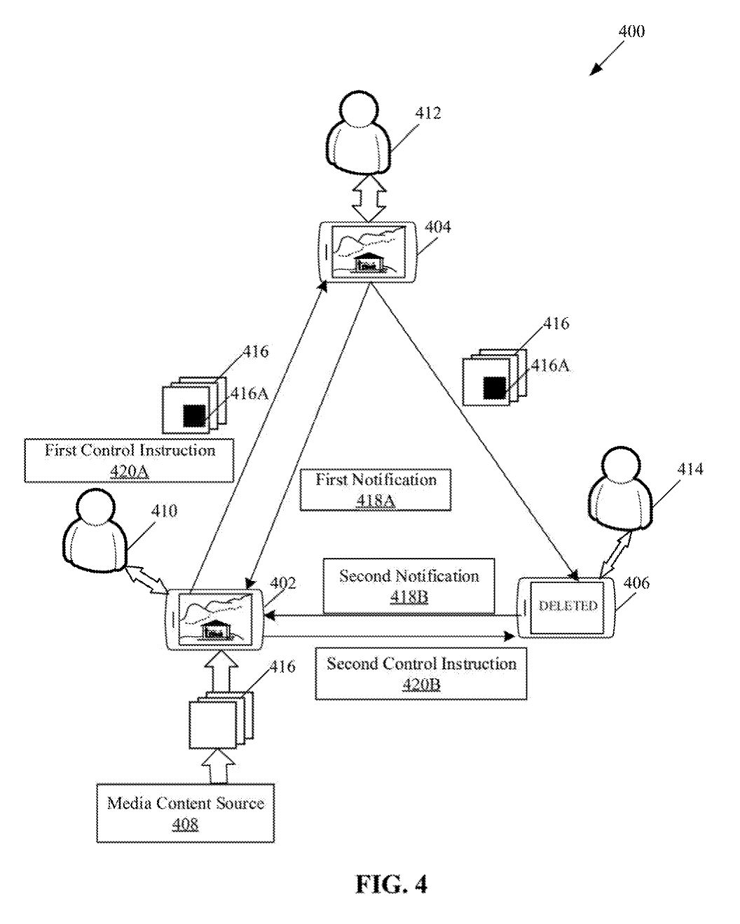

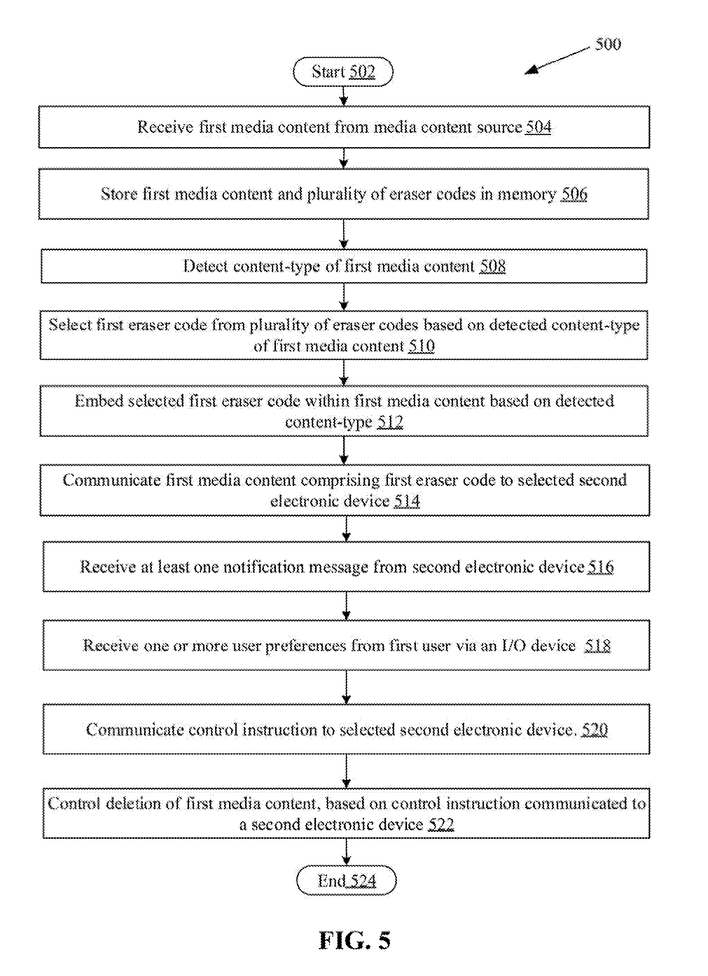

In operation, the memory 204 may be configured to store a first media content and a plurality of eraser codes. The processor 202 may be configured to detect a content-type of the first media content. The processor 202 may be further configured to select a first eraser code from the plurality of eraser codes based on the detected content-type of the first media content. The processor 202 may be further configured to embed the selected first eraser code within the first media content based on the detected content-type, using the code embedder 208. The processor 202 may be further configured to communicate the first media content comprising the first eraser code to a selected second electronic device 104. The processor 202 may be configured to communicate a control instruction to the selected second electronic device 104. The processor 202 may be configured to control deletion of at least a portion of the first media content at the second electronic device 104, based on the communicated control instruction and the first eraser code embedded in the first media content. The functions and/or operations performed by the first electronic device 102, as described in FIG. 1, may also be performed by the processor 202. Other operations performed by the processor 202 is described, for example, in FIGS. 4 and 5.

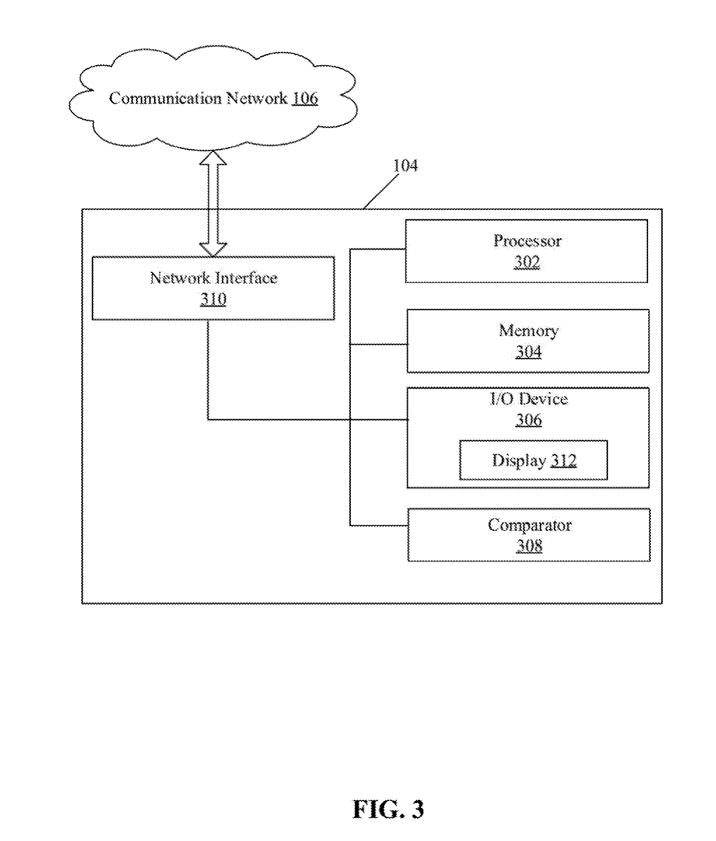

FIG. 3 is a block diagram that illustrates an exemplary electronic device for distribution and access management of individual media content, in accordance with an embodiment of the disclosure. FIG. 3 is explained in conjunction with elements from FIGS. 1 and 2. With reference to FIG. 3, there is shown the second electronic device 104. The second electronic device 104 may include one or more processors, such as a processor 302, a memory 304, an I/O device 306, a comparator 308, and a network interface 310. The processor 302 may be communicatively coupled with the memory 304, the I/O device 306, the comparator 308, and the network interface 310. The network interface 310 may be configured to communicate with the first electronic device 102 or the server 108, via the communication network 106.

The processor 302 may comprise suitable logic, circuitry, interfaces, and/or code that may be configured to execute a set of instructions stored in the memory 304. The processor 302 may be implemented based on various processor 302 technologies known in the art. Examples of the implementation of the processor 302 may be similar to that of the processor 202.

The memory 304 may comprise suitable logic, circuitry, and/or interfaces that may be configured to store a set of instructions executable by the processor 302. The memory 304 may be configured to store the first media content received from the first electronic device 102 in a memory space. The memory 304 may be configured to store operating systems and associated applications. Examples of implementation of the memory 304 may be similar to that of the memory 204.

The I/O device 306 may comprise suitable logic, circuitry, interfaces, and/or code that may be configured to receive an input from a user, such as the second user 112. The I/O device 306 may be further configured to provide an output to the second user 112. The I/O device 306 may comprise various input and output devices that may be configured to communicate with the processor 302. Examples of the input devices may include, but are not limited to, a touch screen, a keyboard, a mouse, a joystick, a microphone, and/or an image-capture unit. Examples of the output devices may include, but are not limited to, the display 312 and/or a speaker.

The comparator 308 may comprise suitable logic, circuitry, interfaces, and/or code that may be configured to perform one or more operations, such as comparing the update in the one or more view parameters with the one or more access control parameters. Examples of implementation of the comparator 308 may include, but are not limited to, an Application Specific Integrated Chip (ASIC), a Field Programmable Gate Array (FPGA), and executable code executed by at least one microprocessor.

The network interface 310 may comprise suitable logic, circuitry, interfaces, and/or code that may be configured to establish communication with the first electronic device 102 or the server 108, via the communication network 106. The network interface 310 may be implemented by use of various known technologies to support wired or wireless communication of the second electronic device 104 with the communication network 106. The network interface 310 may be similar to that of the network interface 210.

The display 312 may comprise suitable logic, circuitry, interfaces, and/or code that may be configured to render one or more media content received from the first electronic device 102. In accordance with an embodiment, the display 312 may be able to receive input from the second user 112. In such a scenario, the display 312 may be a touch screen that enables the second user 112 to provide input. The touch screen may correspond to at least one of a resistive touch screen, a capacitive touch screen, or a thermal touch screen. The display 312 may be similar to the display 212.

In operation, the processor 302 may be configured to receive a first media content comprising a first eraser code embedded in the first media content, from the first electronic device 102. The processor 302 may be also configured to receive a control instruction from the first electronic device 102. The processor 302 may be further configured to update a change in one or more view parameters of the first media content in the first eraser code embedded in the first media content. Moreover, the processor 302 may be configured to compare the update in the one or more view parameters with one or more access control parameters provided in the first eraser code embedded within the first media content, via the comparator 308. The processor 302 may be configured to control deletion of at least a portion of the first media content stored in a memory space of the memory 304 of the second electronic device 104 based on the received control instruction and the comparison. The functions and/or operations performed by the second electronic device 104, as described in FIG. 1, may also be performed by the processor 302. Other operations performed by the processor 302 is described, for example, in FIGS. 4, 5, and 6.

FIG. 4 illustrates an exemplary scenario for implementation of the disclosed electronic device and method for distribution and access management of individual media content, in accordance with an embodiment of the disclosure. FIG. 4 is explained in conjunction with elements from FIGS. 1, 2, and 3. With reference to FIG. 4, there is shown an exemplary scenario 400. The exemplary scenario 400 may include one or more electronic devices, such as a first smartphone 402, a second smartphone 404, a third smartphone 406, a media content source 408, and one or more users 410, 412, and 414. There is further shown a video 416, a first eraser code 416A within the video 416, notifications 418A and 418B, and control instruction 420A and 420B.

In accordance with the exemplary scenario, the first smartphone 402, the second smartphone 404, and the third smartphone 406 may correspond to one of the first electronic device 102 or the second electronic device 104. The media content source 408 may be a source from where video 416 is obtained. For example, the media content source 408 may refer to an image-capture unit (not shown) that may be configured to capture the video 416. The image-capture unit may be an integrated camera or an external camera communicatively coupled to the first smartphone 402. The media content source 408 may also refer to an external storage, such as a flash drive, the server 108, a content production system, and the like, from where the video 416 may be received.

In operation, the first smartphone 402 may be configurable to receive the video 416 from the media content source 408. The video 416 may be an MPEG2 format video, an AVI format video, a Windows Media Video (WMV), or video in other file formats, and/or a video stream.

The first smartphone 402 may be configured to store the video 416. A plurality of eraser codes may be pre-stored in the first smartphone 402. In some embodiments, the plurality of eraser codes may be retrieved from the server 108 (FIG. 1). The first smartphone 402 may be configured to detect the content-type of the received media content, such as the video 416, as a video file in a first file format, such as MPEG2 video file. The first smartphone 402 may be configured to select the first eraser code 416A from the plurality of eraser codes based on the detected content-type of the video 416. For example, if the first media content is the MPEG2 video file, then the first smartphone 402 may select the first eraser code which may be executable to handle or track distribution of the MPEG2 video file once communicated to other devices. The first eraser code 416A comprises one or more access control parameters associated with the video 416. The one or more access control parameters may comprise a recipient identifier (ID) associated with the video 416. In an exemplary illustration, the user 410 may authorize another user, such as the user 412 to view the first media content. Therefore, the recipient ID may indicate an Internet Protocol (IP) address of the second smartphone 404 controlled by the user 412. The first smartphone 402 may be configured to enable the user 410 to modify the one or more access control parameters. The first smartphone 402 may be further configured to update the selected first eraser code based on the modified one or more access control parameters. For example, the first smartphone 402 may update the first eraser code to comprise the recipient ID.

The first smartphone 402 may be configured to embed the selected first eraser code within the first media content based on the detected content-type of a video file comprising the video 416. The first smartphone 402 may be configured to communicate the video 416 comprising a first eraser code 416A embedded within the video 416, to the second smartphone 404, as shown. The second smartphone 404 may be configured to download and store the video 416 with the first eraser code 416A in a memory space of a memory of the second smartphone 404. When the user 412 attempts to access the video 416 with the first eraser code 416A, then the first eraser code 416A embedded within the video 416, may be auto-executed by the second smartphone 404 to determine recipient ID of the user 412 or the second smartphone 404. In one example, the recipient ID of the user 412 may correspond to the user ID, contact number, or social user ID associated with the user 412, or device ID or IP address of the second smartphone 404. Moreover, the recipient ID provided in the first eraser code 416A embedded in the video 416 may be compared with the determined recipient ID of the user 412 or the second smartphone 404. If the recipient ID provided in the first eraser code 416A embedded in the video 416 matches with the recipient ID of the second smartphone 404 (such as user ID of user 412), then the first eraser code 416A may not delete the video 416, and the video 416 may be viewable at the second smartphone 404. If the recipient ID mismatches with the user ID of the user 412, then the second smartphone 404 may send a first notification 418A to the first smartphone 402. The first notification 418A may include a recipient ID (such as user ID of user 412) of the unauthorized device that has made attempt to view the video 416. In one embodiment, the first smartphone 402 may send a first control instruction 420A to the second smartphone 404 and thereby control deletion of the video 416 at the second smartphone 404. Based on the received first control instruction 420A, the first eraser code 416A embedded within the video 416 may be invoked (or triggered) to delete the video 416.

In certain scenarios, the user 412 may forward the video 416 to the third smartphone 406 associated with the user 414. In cases where an attempt is made to play the video 416 on the third smartphone 406, the first eraser code 416A embedded within the video 416 may be auto-executed at the third smartphone 406. The third smartphone 406 may be configured to match the recipient ID(s) provided in the first eraser code 416A matches with the recipient ID associated with the third smartphone 406 (such as user ID of the user 414). If there is a mismatch, then at the time of start of decoding of the video 416 at the third smartphone 406 to view the video 416, the first eraser code 416A embedded in the video 416, may be executed to delete the video 416 at the third smartphone 406. In some embodiments, instead of an immediate deletion, access of the video 416 may be denied, and the third smartphone 406 may generate a second notification 4186 using the embedded first eraser code 416A. In one example, the second notification 418B may comprise at least one of the IP address of the third smartphone 406 or the user ID or name of the user 414. The second notification 4186 may be at least one of an audio based, an image based, a video based, or a text based notification.

The first smartphone 402 may be configured to receive the second notification 418B from the third smartphone 406. The first smartphone 402 may be configured to present the second notification 4186 to the first user 110. The user 410 may provide an input on the first smartphone 402 to set one or more user preferences. For example, the one or more user preferences may include a first preference to erase the first media content immediately, a second preference to erase the first media content partially, a third preference to prevent the third smartphone 406 from erasing the first media content, or a fourth preference to modify the access control parameters of the first eraser code 416A embedded in the video 416 remotely. Moreover, the first smartphone 402 may be configured to generate a second control instruction 420B to erase the first media content from the third smartphone 406 based on the set user preference, such as the first preference.

The first smartphone 402 may be further configured to communicate the second control instruction 420B to the third smartphone 406. The third smartphone 406 may delete the first media content after reception of the second control instruction 420B, thereby enabling the first smartphone 402 to control deletion of the first media content based on the second control instruction 420B. Thus, undesired access of a private media content or further distribution and access of the private media content, such as the video 416, to unauthorized viewers at individual file level, such the video 416, is controlled effectively by the first eraser code 416A embedded within the video 416.

FIG. 5 depict a flowchart that illustrates an exemplary method for distribution and access management of individual media content, in accordance with one embodiment of the present disclosure. With reference to FIG. 5, there is shown a flow chart 500. The flow chart 500 is described in conjunction with elements from FIGS. 1 to 4. The method starts at 502 and proceeds to 504. The method in the flowchart 500 may be implemented in the first electronic device 102.

At 504, a first media content may be received by the first electronic device 102 from a media content source. The processor 202 may be configured to receive the first media content from the media content source. The media content source (such as the media content source 408) may be a source from where the first media content is obtained.

At 506, the first media content and a plurality of eraser codes may be stored in the first electronic device 102. The memory 204 may be configured to store the first media content and the plurality of eraser codes. The plurality of eraser codes may refer to a set of instructions, logic, or code, which may be self-executable, and on execution may perform defined operations. Each of the plurality of eraser codes may include one or more access control parameters and one or more view parameters, as described, for example, in FIG. 1.

At 508, a content-type of the first media content may be detected. The processor 202 may be configured to detect the content-type of the first media content. The memory 204 may comprise a routine for detecting the content-type of the first media content. The content-type of the first media content may be detected by executing the routine.

At 510, a first eraser code from the plurality of eraser codes, may be selected based on the detected content-type of the first media content. The processor 202 may be configured to select the first eraser code from the plurality of eraser codes based on detected content-type of the first media content.

At 512, the selected first eraser code may be embedded within the first media content. The processor 202 may be configured to embed the selected eraser code based on the detected content-type, by use of the code embedder 208. In one example, the processor 202 may be configured to embed the selected eraser code as a self-executable metadata in the first media content.

At 514, the first media content comprising the first eraser code may be communicated to a selected second electronic device 104. The processor may be configured to communicate the first media content to the selected second electronic device 104. The first electronic device 102 may communicate the first media content to the second electronic device 104 via the communication network 106.

At 516, a notification message may be received by the first electronic device 102 from the second electronic device 104. The processor 202 may be configured to receive the notification message, by use of the network interface 210. The first electronic device 102 may be configured to present the notification message to the first user 110.

The notification message may be at least one of an audio-based, an image-based, a video based, or a text based notification message. It may be noted that the second electronic device 104 generates the notification message after executing the first eraser code embedded in the first media content.

At 518, one or more user preferences may be received from the first user 110, via an I/O device 206. The processor 202 may be configured to receive the one or more user preferences based on an input by the first user 110. In one example, the one or more user preferences may include a first preference to erase the first media content in entirety, a second preference to erase at least a portion of the first media content, a third preference to prevent the second electronic device 104 from erasing the first media content, and a fourth preference to modify the one or more access control parameters in the first eraser code embedded in the first media content, to postpone or prepone erasure of the first media content at the second electronic device 104. In some embodiments, the first electronic device 102 may be configured to generate a control instruction based on the one or more user preferences.

At 520, the control instruction may be communicated by the first electronic device 102 to the selected second electronic device 104. The processor 202 may be configured to communicate the control instruction to the selected second electronic device 104. For example, the control instruction may invoke the first eraser code embedded within the first media content, to delete the first media content in its entirety.

At 522, deletion of the first media content may be controlled at the second electronic device 104, by the first electronic device 102. The deletion may be controlled based on the first eraser code embedded in the first media content and the communicated control instruction. In accordance with an embodiment, the first electronic device 102 may be configured to control deletion of at least one portion of the first media content. It may be noted that the second electronic device 104 deletes the first media content based on the communicated control instruction. In one exemplary illustration, the first electronic device 102 may be configured to control the deletion of at least the portion of the first media content at the second electronic device 104 after invoking the first eraser code embedded in the first media content. In one example, the first electronic device 102 may be configured to change the first timestamp in the first eraser code to a second timestamp. The first electronic device 102 may be configured to control the deletion of the portion of the first media content at the second timestamp, based on the communicated control instruction. In another example, the first electronic device 102 may be configured to deny access of the first media content to the second user 112 based on the communicated control instruction. The control may pass to end 524.

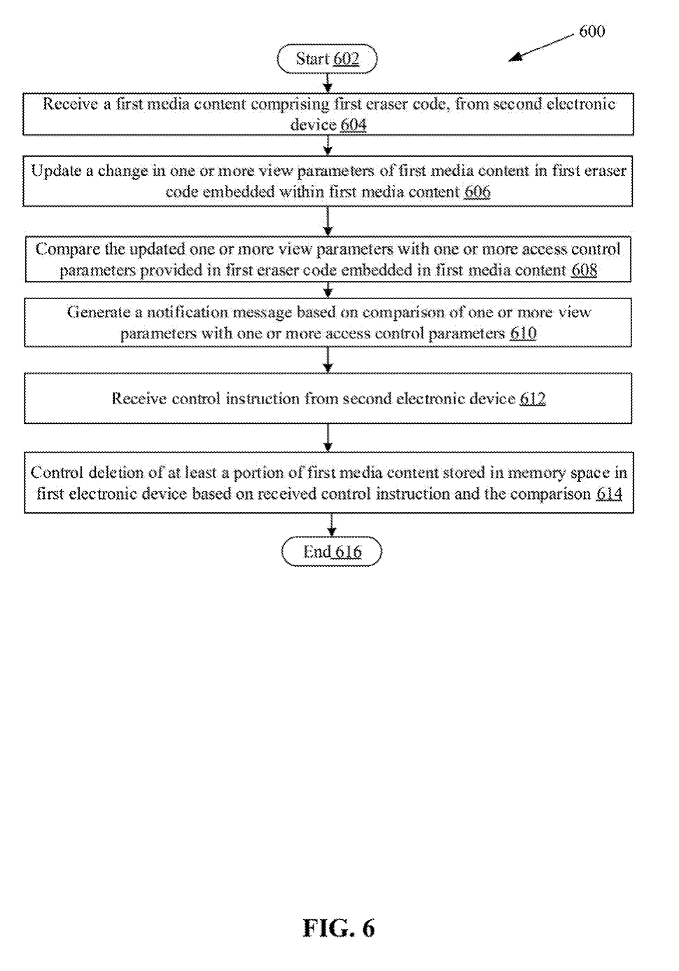

FIG. 6 depict a flowchart that illustrates another exemplary method for distribution and access management of individual media content, in accordance with one embodiment of the present disclosure. With reference to FIG. 6, there is shown a flow chart 600. The flow chart 600 is described in conjunction with elements from FIGS. 1 to 5. The method starts at 602 and proceeds to 604. The method shown in the flowchart 600 is implemented in the first electronic device 102 that may act as a recipient device, whereas the second electronic device 104 acts as a sender device.

At 604, a first media content comprising a first eraser code embedded in the first media content, may be received by the first electronic device 102. The processor 202 may be configured to receive the first media content from the second electronic device 104. The first eraser code may refer to a set of instructions, logic, or code, which may be self-executable, and on execution may perform defined operations. The first eraser code may include one or more access control parameters, for example, a view count limit, a user-defined expiration time for a media content, a placeholder for one or more recipient identifiers (IDs) of one or more recipients to whom a media content may be communicated. The first eraser code may further include one or more view parameters, for example, a current view count, a placeholder for one or more user identifiers (IDs) of one or more user who may access the media content, as discussed, for example, in FIG. 1.

At 606, the one or more view parameters stored within the eraser code may be updated by the first electronic device 102. The processor 202 may be configured to update the one or more view parameters. The processor 202 may be configured to determine the one or more view parameters by use of the first eraser code embedded in the first media content. In one example, the first electronic device 102 may be configured to increment the current view count each time a viewer accesses the first media content on the first electronic device 102.

At 608, the updated one or more view parameters may be compared with the one or more access control parameters provided in the first eraser code embedded in the first media content. The processor 202 may be configured to compare the one or more view parameters with the one or more access control parameters. For example, the first electronic device 102 may be configured to compare the current view count with the view count limit specified in the first eraser code embedded in the first media content. The secondary electronic device may compare the update in the one or more view parameters with the one or more access control parameters by invoking the first eraser code embedded in the first media content.

At 610, a notification message may be generated based on the comparison of one or more view parameters with the one or more access control parameters. For example, if the user ID of the first electronic device 102 mismatches with the recipient ID specified in the first eraser code embedded in the first media content, then the first electronic device 102 communicates the user ID to the second electronic device 104 via the notification message.

At 612, a control instruction may be received from the second electronic device 104. The processor 202 may be configured to receive the control instruction from the second electronic device 104, via the communication network 106.

At 614, the deletion of at least the portion of the first media content in a memory space in the first electronic device 102 may be controlled based on the received control instruction and the comparison of the one or more view parameters with the one or more access control parameters. The processor 202 may be configured to control deletion of the first media content based on the comparison of the one or more view parameters and the one or more access control parameters. The control may pass to end 616.

In accordance with one embodiment of the present disclosure, a first electronic device (such as the first electronic device 102 (FIG. 1)) for distribution and access management of individual media content is disclosed. The first electronic device 102 may include a memory (such as the memory 204 (FIG. 2)). The memory 204 may be configured to store a first media content (e.g. the video 416 (FIG. 4)) and a plurality of eraser codes. The first electronic device 102 may further include a central processing unit (CPU) (such as the processor 202 (FIG. 2)). The processor 202 may be configured to detect a content-type of the first media content. The processor 202 may be configured to select a first eraser code (e.g. the first eraser code 416A (FIG. 4)) from the plurality of eraser codes based on the detected content-type of the first media content. The processor 202 may be further configured to embed the selected first eraser code within the first media content based on the detected content-type. The processor 202 may be further configured to communicate the first media content comprising the first eraser code to a selected second electronic device (such as the second electronic device 104 (FIG. 1)). The processor 202 may be configured to communicate a control instruction (e.g. first control instruction 420A (FIG. 4)) to the selected second electronic device 104. The processor 202 may be further configured to control deletion of at least a portion of the first media content at the second electronic device 104, based on the first eraser code embedded in the first media content and the communicated control instruction.

In accordance with an exemplary aspect of the present disclosure, a first electronic device (such as the first electronic device 102 (FIG. 1)) for distribution and access management of individual media content is disclosed. The first electronic device may comprise a central processing unit (CPU) (such as the processor 202 (FIG. 2)). The processor 202 may be configured to receive a first media content (e.g. the video 416 (FIG. 4)), comprising an embedded first eraser code (e.g. the first eraser code 416A (FIG. 4)) from a second electronic device (such as the second electronic device 104 (FIG. 1)). The processor 202 may be configured to receive a control instruction (e.g. the first control instruction 420A (FIG. 4)) from the second electronic device 104. The processor 202 may be further configured to update a change in one or more view parameters of the first media content in the embedded first eraser code of the first media content. The processor 202 may be further configured to compare the update in the one or more view parameters with one or more access control parameters provided in the embedded first eraser code of the first media content. The processor 202 may be further configured to control deletion of at least a portion of the first media content stored in a memory space (of the memory 204) in the first electronic device 102 based on the received control instruction and the compare.

Currently, there are certain challenges in the file distribution systems, social media applications and platforms with regards to information security, file distribution control, and data access management at individual file level. The users of the social media applications may be prone to privacy right violations. For example, a user of a sender device may inadvertently communicate a private media content to an undesired recipient device. In such a case, the user may be unable to track or handle the communicated private media content at the recipient device. Moreover, after reception of the private media content, a recipient may forward the private media content to undesired or unauthorized viewers. It may be difficult for the user to prevent further distribution and access of the communicated media content. In order to solve the above challenges, the disclosed first electronic device (such as the first electronic device 102 (FIG. 1)), embeds an eraser code within a media content by the code embedder 208 so as to track, and handle the media content (e.g., an individual media file) once the file has been transmitted to the second electronic device 104. The first eraser code embedded in the first media content may be auto-executed for self-erasure of the embedded first eraser code as well as the first media content. Additionally, the processor 202 may remotely control deletion of at least a portion of the first media content or the entire media content at the second electronic device 104, based on the first eraser code embedded in the first media content and the communicated control instruction, as described, for example, in FIGS. 1 to 6.

Various embodiments of the disclosure may provide another non-transitory computer readable medium and/or storage medium, where there is stored therein, a set of instructions executable by a machine and/or a computer for distribution and access management of individual media content items. The set of instructions may cause the machine and/or computer to perform operations that comprise storage of a first media content and a plurality of eraser codes, detection of a content-type of the first media content, and selection of a first eraser code from the plurality of eraser codes based on the detected content-type. The first eraser code may be embedded within the first media content based on the detected content-type. The first media content comprising the first eraser code may be communicated to a second electronic device. Further, deletion of at least a portion of the first media content at the second electronic device, may be controlled based on the communicated control instruction.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departure from its scope. Therefore, it is intended that the present disclosure not be limited to the particular embodiment disclosed, but that the present disclosure will include all embodiments that fall within the scope of the appended claims.

What is claimed is:

1. A first electronic device for distribution and access management of individual media content, comprising:
a memory configured to store a first media content and a plurality of eraser codes; and
a central processing unit (CPU) configured to:
detect a content-type of the first media content;
select a first eraser code from the plurality of eraser codes based on the detected content-type of the first media content;
embed the selected first eraser code within the first media content based on the detected content-type;
communicate the first media content comprising the first eraser code to a selected second electronic device;
communicate a control instruction to the selected second electronic device; and
control deletion of at least a portion of the first media content at the second electronic device, based on the first eraser code embedded within the first media content and the communicated control instruction.

2. The first electronic device according to claim 1, wherein the first media content is one of a video file, an audio file, an image file, or a media content stream.

3. The first electronic device according to claim 1, wherein the CPU is further configured to control the deletion of at least the portion of the first media content at the second electronic device using the first eraser code which is invoked to delete the portion of the first media content after elapse of a defined time period based on the communicated control instruction.

4. The first electronic device according to claim 1, wherein the CPU is further configured to change a first timestamp in the first eraser code embedded within the first media content to a second timestamp to control the deletion of the portion of the first media content at the second timestamp, based on the communicated control instruction.

5. The first electronic device according to claim 1, wherein the CPU is further configured to detect a change in an access rights setting in a memory space of the second electronic device in which the first media content is stored based on a message received from the second electronic device, wherein the first media content is automatically deleted by the first eraser code embedded within the first media content from the memory space based on a change in the access rights setting to a read-only access right assigned to the memory space.

6. The first electronic device according to claim 1, wherein the CPU is further configured to embed the selected first eraser code in the first media content as self-executable metadata.

7. The first electronic device according to claim 1, wherein the CPU is further configured to control deletion of the first media content in entirety at the second electronic device based on the communicated control instruction.

8. A first electronic device for distribution and access management of individual media content, comprising:
a central processing unit (CPU) configured to:
receive a first media content comprising a first eraser code from a second electronic device;
receive an control instruction from the second electronic device;
update a change in one or more view parameters of the first media content in the first eraser code embedded within the first media content;
compare the update in the one or more view parameters with one or more access control parameters provided in the first eraser code embedded within the first media content;
control deletion of at least a portion of the first media content stored in a memory space in the first electronic device based on the received control instruction and the compare.

9. The first electronic device according to claim 8, wherein the one or more access control parameters comprises at least one of a view count limit, a user-defined expiration time for the first media content, and a recipient identifier (ID) associated with the first media content.

10. The first electronic device according to claim 8, wherein the one or more view parameters comprises at least one of a current view count associated with the first media content, and a user identifier (ID) associated with a user of the first electronic device.

11. The first electronic device according to claim 8, wherein the CPU is further configured to determine the one or more view parameters of the first media content each time the first media content is accessed.

12. The first electronic device according to claim 8, wherein the CPU is further configured to modifying a first timestamp in the first eraser code embedded within the first media content to a second timestamp to control the deletion of the portion of the first media content at the second timestamp, based on the received control instruction.

13. The first electronic device according to claim 8, wherein the CPU is further configured to execute the first eraser code embedded within the first media content to delete the first media content in entirety based on a change in an access rights setting to a read-only access right, wherein the access rights setting of read-only access right is assigned to a memory space in the first electronic device in which the first media content is stored.

14. A method for distribution and access management of individual media content, comprising:
in a first electronic device comprising a memory and a central processing unit (CPU):
storing, by the CPU, a first media content and a plurality of eraser codes in the memory;
detecting, by the CPU, a content-type of the first media content;
selecting, by the CPU, a first eraser code from the plurality of eraser codes based on the detected content-type of the first media content;
embedding, by the CPU, the selected first eraser code within the first media content based on the detected content-type;
communicating, by the CPU, the first media content comprising the first eraser code to a selected second electronic device;
communicating, by the CPU, an control instruction to the selected second electronic device; and
controlling, by the CPU, deletion of at least a portion of the first media content at the second electronic device based on the first eraser code embedded within the first media content and the communicated control instruction.

15. The method according to claim 14, further comprising controlling, by the CPU, the deletion of at least the portion of the first media content at the second electronic device using the first eraser code which is invoked to delete the portion of the first media content after elapse of a defined time period, based on the communicated control instruction.

16. The method according to claim 14, further comprising detecting, by the CPU, a change in an access rights setting of a memory space of the second electronic device, in which the first media content is stored, based on a message received from the second electronic device, wherein the first media content is automatically deleted by the first eraser code embedded within the first media content from the memory space based on a change in the access rights setting to a read-only access right assigned to the memory space.

17. The method according to claim 14, further comprising controlling, by the CPU, deletion of the first media content in entirety at the second electronic device based on the communicated control instruction.

18. A method for distribution and access management of individual media content, comprising:
in a first electronic device comprising a memory and a central processing unit (CPU):
receiving, by the CPU, a first media content comprising a first eraser code from a second electronic device;
receiving, by the CPU, an control instruction from the second electronic device;
updating, by the CPU, a change in one or more view parameters of the first media content in the first eraser code embedded within the first media content;
comparing, by the CPU, the update in the one or more view parameters with one or more access control parameters provided in the first eraser code embedded within the first media content; and
controlling, by the CPU, deletion of at least a portion of the first media content stored in a memory space in the first electronic device based on the received control instruction and the compare.

19. The method according to claim 18, further comprising, determining, by the CPU, the one or more view parameters of the first media content each time the first media content is accessed.

20. The first electronic device according to claim 8, further modifying, by the CPU, a first timestamp in the first eraser code embedded within the first media content to a second timestamp to control the deletion of the portion of the first media content at the second timestamp, based on the received control instruction.
